(19) United States
(12) Patent Application Publication
(10) Pub. No.: US 2008/0253134 A1
(43) Pub. Date: Oct. 16, 2008

(54) OPTICAL MODULE

(75) Inventors: Sung-Ho Byun, Suwon-si (KR); Byoung-Ki Song, Suwon-si (KR)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: SAMSUNG ELECTRO-MECHANICS CO., LTD., Suwon (KR)

(21) Appl. No.: 12/062,448

(22) Filed: Apr. 3, 2008

(30) Foreign Application Priority Data
Apr. 10, 2007 (KR) 10-2007-0034976

(51) Int. Cl. F21V 15/01

(52) U.S. Cl. 362/362

(57) ABSTRACT

An optical module is disclosed. In accordance with an embodiment of the present invention, the optical module can include a light source, emitting one of red, green and blue beam of light in the optical module; a light source holder, including a first chamber accommodating the light source, a first adhering part and a holder joint part being formed in an edge or corner of the first chamber; and a main base, including a second chamber accommodating the light source holder, a second adhering part that is adhered to the first adhering part and a base joint part that is in contact with the holder joint part being formed in an edge or corner of the second chamber. With present invention, the optical module can have its improved heat-resisting and impact-resisting properties.

### CROSS-REFERENCE TO RELATED PATENT APPLICATIONS

This application claims the benefit of Korean Patent Application No. 10-2007-0034976, filed on Apr. 10, 2007, in the Korean Intellectual Property Office, the disclosure of which is incorporated herein in its entirety by reference.

### BACKGROUND OF THE INVENTION

1. Field of the Invention

The present invention relates to an optical module, more specifically to an optical module in which a laser diode, for example, is settled at a main base through a holder.

2. Background Art

An optical module for optical display includes a three-primary color laser light source, an optical system necessary for combination and separation of three-primary colors, an optical modulator loading an image signal on the three-primary color beams of light (e.g. a laser beam of light) and a driving circuit driving a system by electronically processing the image signal.

Here, the three-primary color laser light source (e.g. a red light source, a blue light source and a green light source) is settled and/or adhered in the optical module. Conventionally, theses light sources are settled at a main base of the optical module by using a welding method. Before the welding, the positions of the light sources can be three-dimensionally changed by 6-axis adjustment.

Also, the main base and the light source are conventionally are settled in a bridge type. The bridge type indicates that the main base and the light source are settled and are in contact with each other through a contact point (e.g. the contact point placed at an edge or corner) only.

Accordingly, since in the case of the optical module in which a light source is conventionally settled, it is required to perform the 6-axis adjustment, adjusting the position of the light source is complex and difficult. As a result, adjusting the position of the light source requires a lot of times, which cause the mass-production to be lowered and the unit prices of products to be higher. Further, performing three-dimensional complex adjustment leads to the increase of the overall size of the optical module.

The small area in which the main base and the optical modulator are in contact with each other causes the heat-resisting property to be lowered. The optical module having a light source settled in the bridge type is also easily affected by an impact.

### SUMMARY OF THE INVENTION

The present invention provides an optical module that can easily adjust the position of a settled optical module.

The present invention also provides an optical module that can have its heat-resisting property improved.

The present invention provides an optical module that can have a light source settled and adhered with impact-resistance.

The present invention provides an optical module that can increase mass production by simplifying the operations for adjusting and settling a light source.

The present invention provides an optical module that can simplify the operations for adjusting and settling a light source to easily deal with an error.

An aspect of the present invention features an optical module including a light source, emitting any one of red, blue and green beams of light in the optical module; a light source holder, including a first chamber accommodating the light source, a first adhering part and a holder joint part being formed in an edge or corner of the first chamber; and a main base, including a second chamber accommodating the light source holder, a second adhering part that is adhered to the first adhering part and a base joint part that is in contact with the holder joint part being formed in an edge or corner of the second chamber.

The light source can have its position changed in a two-dimensional plane in parallel with the second chamber before being settled in the holder.

The light source can have its position changed by two orthogonal axes of the two-dimensional plane before being settled in the holder.

The light source can emit a laser beam to another element of the optical module through a hole of a bottom surface of the light source holder.

The light holder can accommodates the light source by allowing an inner wall of the first chamber to be in contact with an outer wall of the light source.

The holder joint part can be placed at least two of each corner of an upper surface of the light source holder.

The first adhesion part can be placed at least two of each corner of an upper surface of the light source holder.

The holder joint part can be joined to the base joint part by a screw.

The first adhering part can be adhered to the second adhering part by applying a UV bond to any one of the first adhering part and the second adhering part.

The light source can be at least one of a green laser diode, a green laser diode and a blue laser diode.

The light source can be settled to the light source holder by an adhering material.

### BRIEF DESCRIPTION OF THE DRAWINGS

These and other features, aspects and advantages of the present invention will become better understood with regard to the following description, appended Claims and accompanying drawings where:

FIG. 1 shows an optical module in accordance with an embodiment of the present invention;

FIG. 2 shows an optical module in accordance with another embodiment of the present invention;

FIG. 3 is a front view showing a light source holder applied to the optical module of FIG. 1;

FIG. 4 is a side sectional view showing a light source holder applied to the optical module of FIG. 1;

FIG. 5 is a front view showing another light source holder applied to the optical module of FIG. 2;

FIG. 6 is a side sectional view showing a light source holder applied to the optical module of FIG. 2;

FIG. 7 shows that a light source is coupled or adhered to a light source holder applied to the optical module of FIG. 1;

FIG. 8 shows that a light source is coupled or adhered to a light source holder applied to the optical module of FIG. 2;

FIG. 9 is a plan view showing a main base in accordance with an embodiment of the present invention;

FIG. 10 is a side sectional view showing the main base of FIG. 9, viewed from a first direction;

FIG. 11 is a side sectional view showing the main base of FIG. 9, viewed from a second direction; and

FIG. 12 shows that the position of a light source is adjusted in an embodiment of the present invention.

### DESCRIPTION OF THE EMBODIMENTS

Since there can be a variety of permutations and embodiments of the present invention, certain embodiments will be illustrated and described with reference to the accompanying drawings. This, however, is by no means to restrict the present invention to certain embodiments, and shall be construed as including all permutations, equivalents and substitutes covered by the spirit and scope of the present invention.

Terms such as “first” and “second” can be used in describing various elements, but the above elements shall not be restricted to the above terms. The above terms are used only to distinguish one element from the other For instance, the first element can be named the second element, and vice versa, without departing the scope of claims of the present invention.

The term “and/or” shall include the combination of a plurality of listed items or any of the plurality of listed items. The terms used in the description are intended to describe certain embodiments only, and shall by no means restrict the present invention. Unless clearly used otherwise, expressions in the singular number include a plural meaning.

In the present description, an expression such as “comprising,” or “mounted” or “equipped” is intended to designate a characteristic, a number, a step, an operation, an element, a part or combinations thereof, and shall not be construed to preclude any presence or possibility of one or more other characteristics, numbers, steps, operations, elements, parts or combinations thereof.

Unless otherwise defined, all terms, including technical terms and scientific terms, used herein have the same meaning as how they are generally understood by those of ordinary skill in the art to which the invention pertains. Any term that is defined in a general dictionary shall be construed to have the same meaning in the context of the relevant art, and, unless otherwise defined explicitly, shall not be interpreted to have an idealistic or excessively formalistic meaning.

Other aspects, features and benefits will become more apparent through the below drawings, claims and detailed description.

Hereinafter, an embodiment of an optical module in accordance with the present invention will be described in detail with reference to the accompanying drawings.

Examples of the structure or operation of an optical module to which an embodiment of the present invention is applicable will be described. In accordance with an embodiment of the present invention, the optical modulator can employ a laser diode as a light source and convert a beam of light emitted from the light source to project pertinent image information on a screen by using a scanner.

The optical modulator can include a light source, including a red light source, a green light source and a blue light source as 3-primary colors of light, an optical system, collecting a beam of light emitted from the light source and an optical separating unit, separating a laser beam incident from the optical system into a single red color beam, a single green beam and a single blue beam. The optical separating unit can include a dichroic mirror and a high-reflective mirror. The dichroic mirror can separate a white color beam into a red color beam, a green color beam and a blue color beam, and the high-reflective mirror can change a path through which a beam of light passes.

The optical module can further include an image signal generating unit, providing an image signal, a synchronizing signal separating unit, separating horizontal and vertical synchronizing signals from the image signal provided from the image signal generating unit, a color signal separating decoder, separating a color signal from the image signal provided from the image signal generating unit, and a high-frequency signal amplifier, amplifying the color signal separated from the color signal separating decoder.

In addition, the optical module can include an optical modulating unit and a light combining unit. Here, the optical modulator can modulate the beam of light incident from the optical system by using the image signal (i.e. the color signal) provided from the high-frequency signal amplifier, and the light combining unit can combine the modulated single red, green and blue beams of light.

The optical modulating unit can include an optical modulator, modulating the single red, green and blue beams to an optical signal of each single color beam. Here, the beam of light provided from the light source can be separated into the single red, green and blue beams by passing through the optical system and the optical separating unit according to the color signal that is separated from the image signal, provided by the image signal generating unit, by the color separating decoder. At this time, the color signal can be amplified by the high-frequency amplifier. In the optical module, a beam of light that is incident from the light source to the optical modulator can be referred to as an incident beam of light. A beam of light that undergoes the foregoing modulation by the optical modulator and is outputted can be referred to as a modulation beam of light. A path through which a beam of light emitted from the light source moves passing through each element of the optical module can be referred to as an optical path.

The optical combining unit can receive single color beams modulated from the optical modulator to combine various colored image signals. Herein, the optical combining unit can include the dichroic mirror for combining single color beams to an image signal in the beam form for being displayed on a screen and the high-reflective mirror for changing a path of the separated single color beam.

Here, the settling structure, in which the aforementioned various elements usable for optical display such as the light source, the high-reflective mirror, the dichroic mirror, the optical modulator and the driving circuit are settled at each predetermined position, can be referred to as a main base.

The light source can be settled and/or adhered at the main base in various ways. The method of settling the light source in accordance with some embodiments of the present invention will be described below.

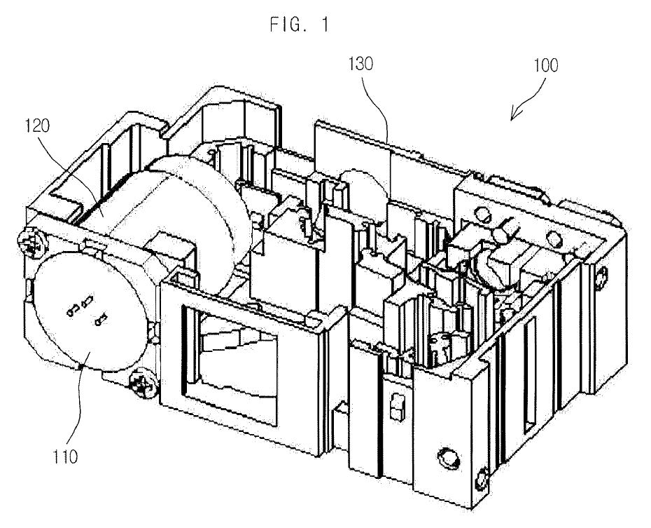

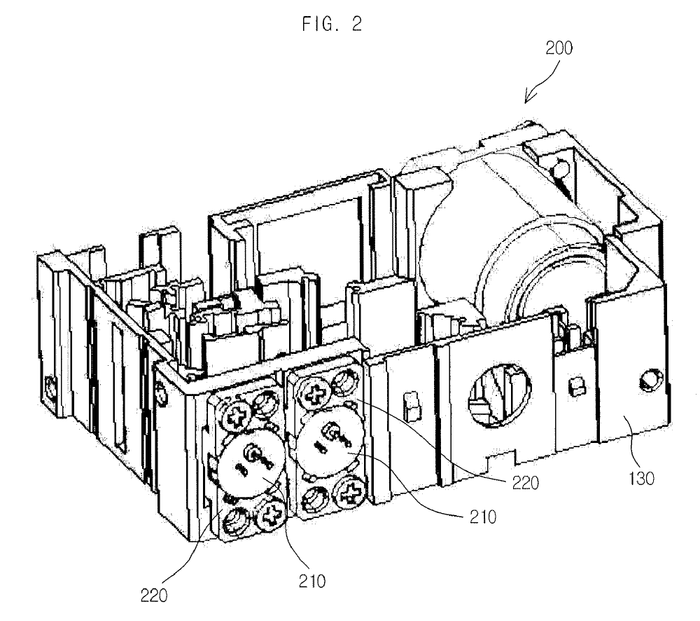

Even though the optical module including red, green and blue light sources are illustrated in FIG. 1 and FIG. 2 for the convenience of illustration, it is natural that the optical module in accordance with the present invention can be manufactured to include at least one of red, green and blue light sources.

FIG. 1 shows an optical module 100 in accordance with an embodiment of the present invention

Referring to FIG. 1, the optical module 100 can include a light source 110, a light source 220 and a main base 130. In accordance with an embodiment of the present invention, the light source 110 can be a green light source, which employs a green laser.

In an embodiment of the present invention, the optical module 100 can be configured to include the light source 110 and the main base 130 by allowing the light source 110 to be adhered to the light source holder 120 settled at the main base 130.

In case that the light source 110 is the green light source that employs the green laser, as the optical display is proceeding according to the operation of the optical module 100, the light source 110 can emit a lot of heat as compared with other elements. As a result, the heat emitted from the light source 110 can be absorbed by the main base 130. This may be because allowing the main base 130 to perform the circulation of heat and cooling makes it possible to prevent the optical module 100 from being heated.

Accordingly, the wider contact area between the light source 110 and the main base 130 can help the heat of the light source 110 to be more efficiently to be transferred to the main base 130. An embodiment of the present invention assumes that the light source 110 is widely in contact with the light source holder 120 and the light source holder 120 is widely in contact with the main base 130.

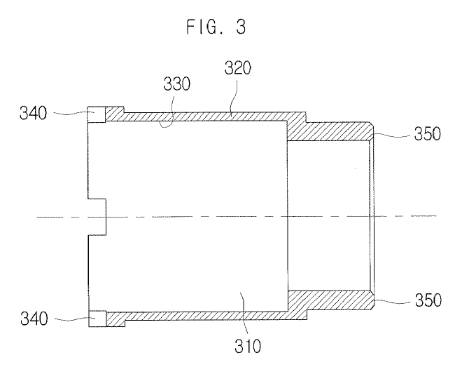

In accordance with an embodiment of the present invention, the light source 110 can be settled in the light source holder 120 by allowing the light source 110 to be inserted into the inside of the light source holder 120, which is a first chamber 310 (refer to FIG. 3) in the optical module 100. In accordance with another embodiment of the present invention, the light source 110 can be settled in the light source holder 120 by a bond in the optical module. The light source holder 120 can adhered to the main base 130 by using a screw or a bond.

FIG. 2 shows an optical module 200 in accordance with another embodiment of the present invention.

Referring to FIG. 2, the optical module 200 can include a light source 210, a light source holder 220 and a main base 130. In accordance with another embodiment of the present invention, the optical module 200 can include two light sources 210. One of the two light sources 210 can be any one of a red light source and a blue light source, and the other can be the other light source. Although the red light source and the blue light source are illustrated in a line in FIG. 2, the configuration and types of the two light sources can be varied depending on the embodiments, which are by no means limit or restrict the spirit and scope of the present invention.

In accordance with another embodiment of the present invention, the optical module 200 can be configured to include the light sources 210 and the main base 130 by allowing the light sources 210 to be adhered to the light source holders 220, respectively, settled at the main base 130.

In case that the light sources 210 are the red and blue light sources, as the optical display is proceeding according to the operation of the optical module 200, the light sources 210 can emit a lot of heat as compared with other elements. As a result, the heat emitted from the light source 110 can be absorbed by the main base 130. This may be because allowing the main base 130 to perform the circulation of heat and cooling makes it possible to prevent the optical module 200 from being heated.

Accordingly, the wider contact area between the light sources 210 and the main base 130 can help the heat of the light sources 210 to be more efficiently to be transferred to the main base 130. Another embodiment of the present invention assumes that the light sources 210 are widely in contact with the light source holders 220 and the light source holders 220 are widely in contact with the main base 130.

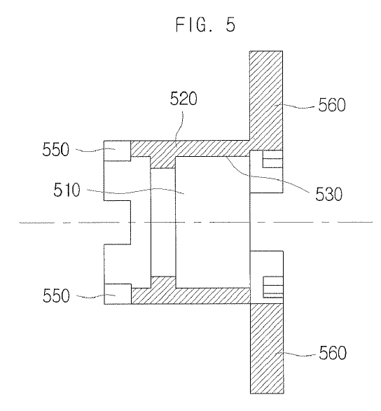

In accordance with another embodiment of the present invention, the light sources 210 can be settled in the light source holders 220 by allowing the light sources 210 to be inserted into each inside of the light source holders 120, which are each first chamber 510 (refer to FIG. 5) in the optical module 100. In accordance with another embodiment of the present invention, the light sources 210 can be settled in the light source holders 220 by a bond in the optical module. The light source holders 220 can be adhered to the main base 130 by using a screw or a bond.

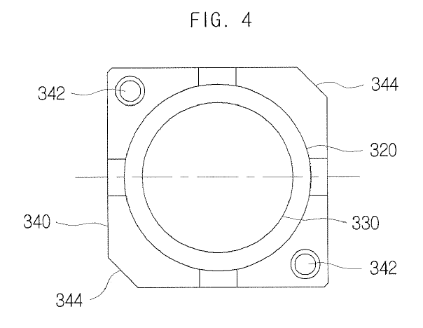

FIG. 3 is a front view showing a light source holder applied to the optical module of FIG. 1, and FIG. 4 is a side sectional view showing a light source holder applied to the optical module of FIG. 1. In accordance with an embodiment of the present invention, the light source 110 can be a green light source.

The light source 110 can be accommodated into a first chamber 310 of the light holder 120. An inner wall 330 can be formed inside a lateral side of the first chamber 310. If the light source 110 is be accommodated into the first chamber 310, allowing an outer wall of the light source 110 to be in contact with the inner wall 330 of the light source holder 120 can settle the light source 110 in the light source holder 120. In accordance with an embodiment of the present invention, in case that the light source is the green light source, a lot of heat may be generated according to the operation of the optical modulator. Here, the wider contact area between the outer wall of the light source 110 and the inner wall 330 of the light source holder 120 can help the heat-resisting property to be improved.

As illustrated in FIG. 4, a holder joint part 342 and/or a first adhering part 344 can be formed in an upper surface 340 of the light source holder 120. The holder joint part 342 can refer to the part coupled between the light source 120 and the main base 130 by joint means such as a screw. Also, the first adhering part 334 can refer to the part coupled between the light source 120 and the main base 130 by an adhering material such as a bond. At this time, a UV bond, a thermosetting bond or a reinforcement bond can be used. The UV bond is cured and settled by using an acrylic or epoxy UV curer.

Referring to FIG. 4, the holder joint part 342 and/or the first adhering part 344 can be symmetrically placed at each corner of the upper surface 340 of the light source holder 120. However, the number and configuration of the holder joint part 342 and the first adhering part 344, shown in FIG. 4, are merely an embodiment of the present invention. The configuration, ratio and number of the holder joint part 342 and the first adhering part 344 can be determined in various ways, which are by no means limit or restrict the spirit and scope of the present invention.

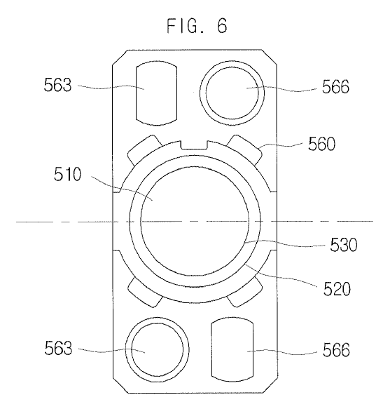

FIG. 5 is a front view showing another light source holder applied to the optical module of FIG. 2, and FIG. 6 is a side sectional view showing a light source holder applied to the optical module of FIG. 2. In accordance with another embodiment of the present invention, the light sources 210 can be a red light source and a blue light source, respectively. The below description is related to any one of the light sources 210. The same description can apply to the other light source.

The light source 210 can be accommodated into a first chamber 510 of the light holder 220. An inner wall 530 can be formed inside a lateral side of the first chamber 510. If the light source 210 is be accommodated into the first chamber 510, allowing an outer wall of the light source 210 to be in contact with the inner wall 530 of the light source holder 220 can settle the light source 210 in the light source holder 220. In accordance with an embodiment of the present invention, in case that the light source is the red or blue light source, a lot of heat may be generated according to the operation of the optical modulator. Here, the wider contact area between the outer wall of the light source 210 and the inner wall 530 of the light source holder 220 can help the heat-resisting property to be improved.

As illustrated in FIG. 6, a holder joint part 563 and/or a first adhering part 566 can be formed in an upper surface 560 of the light source holder 220. The holder joint part 563 can refer to the part coupled between the light source 220 and the main base 130 by joint means such as a screw. Also, the first adhering part 566 can refer to the part coupled between the light source 220 and the main base 130 by an adhering material such as a bond. At this time, a UV bond, a thermosetting bond or a reinforcement bond can be used. The UV bond is cured and settled by using an acrylic or epoxy UV curer.

Referring to FIG. 6, the holder joint part 563 and/or the first adhering part 566 can be symmetrically placed at each corner of the upper surface 560 of the light source holder 220. However, the number and configuration of the holder joint part 563 and the first adhering part 566, shown in FIG. 6, are merely an embodiment of the present invention. The configuration, ratio and number of the holder joint part 563 and the first adhering part 566 can be determined in various ways, which are by no means limit or restrict the spirit and scope of the present invention.

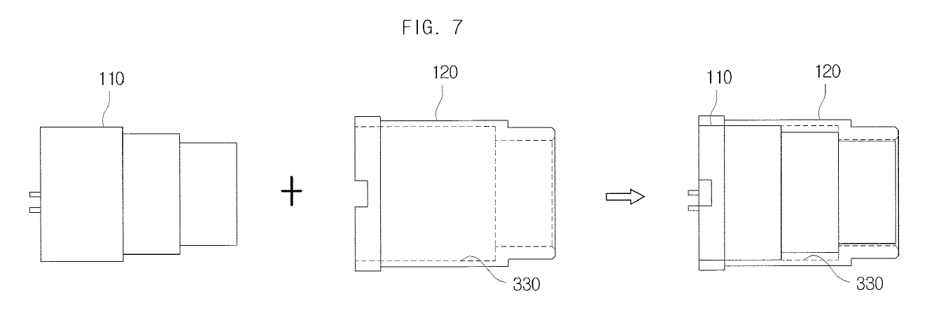

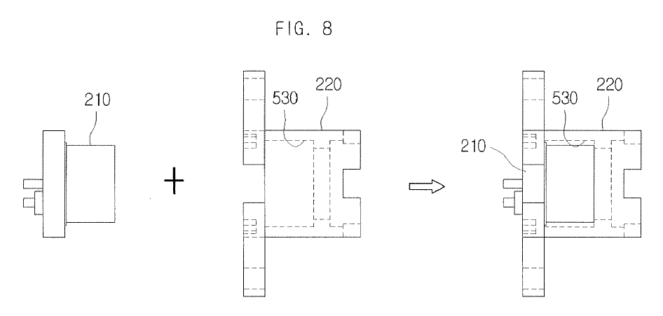

FIG. 7 shows that a light source is coupled or adhered to a light source holder applied to the optical module of FIG. 1, and FIG. 8 shows that a light source is coupled or adhered to a light source holder applied to the optical module of FIG. 2. The light source 110 (e.g. a green light source) can be coupled or adhered to the light source holder 120 corresponding to the green light source, and the light source 210 (e.g. a red or blue light source) can be coupled or adhered to the light source holder 120 corresponding to the red or blue light source.

Referring to FIG. 7 and FIG. 8, a lateral side of the light source holder 120 or 220 can envelop a lateral side of the light source 110 or 210, and the inner wall 330 or 530 can be in contact with an outer wall of the light source 110 or 210. Accordingly, the wider contact area between the light source holder 220 and the main base 130 can help the heat-resisting property of the light source 110 or 210 to be improved. The light source 110 or 210 can be adhered to the light source holder 120 or 220 by an adhering material. This is not shown in FIG. 7 and FIG. 8. The part to which the adhering material is applied or the type of the adhering material has no restriction. For example, UV bond and a thermosetting bond can be used.

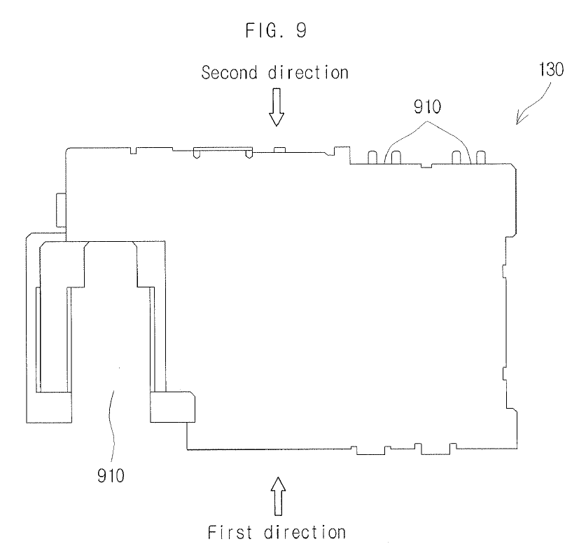

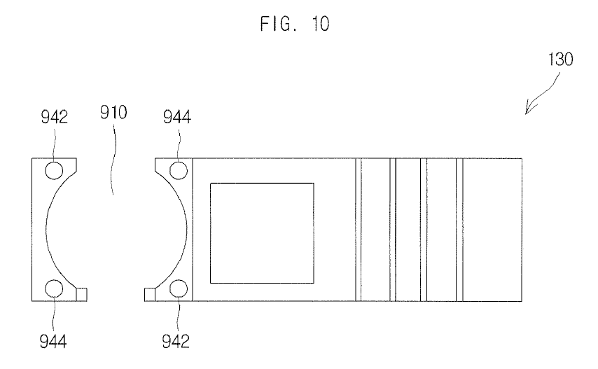

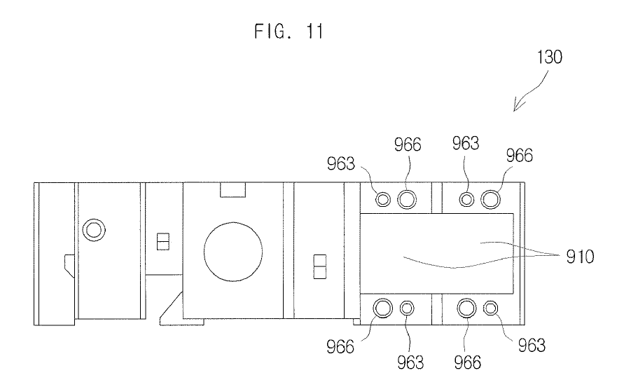

FIG. 9 through FIG. 11 shows the main base 130 in accordance with an embodiment of the present invention. In particular, FIG. 9 is a plan view showing a main base 130 in accordance with an embodiment of the present invention. FIG. 10 is a side sectional view showing the main base 130 of FIG. 9, viewed from a first direction, and FIG. 11 is a side sectional view showing the main base of FIG. 9, viewed from a second direction. A second chamber 910 for accommodating a green light source is illustrated in the side sectional view showing the main base 130 shown in FIG. 10. A second chamber 910 for accommodating a red or blue light source is illustrated in the side sectional view showing the main base 130 shown in FIG. 11.

The main base 130 can include various elements necessary for the operation of an optical module having an optical display as well as the space for accommodating the light source holder 120 or 220 or the light source holder 120 or 220 coupled to the light source 110 or 210. However, since the elements have no direct relationship with the light source holder 120 or 220, the pertinent description will be omitted.

The light source holder 120 or 220 of each light source can be accommodated or inserted into the second chamber 910. Referring to FIG. 9 and FIG. 11, the red light source and the blue light source can be arranged in a line in another embodiment of the present invention. A surface for settling an upper surface of the light source holder 120 or 220 can be placed in an edge or corner of the second chamber 910 of the main base 130. The surface can be formed with a base joint part 942 or 963 and/or a second adhering part 944 or 966.

The base joint part 942 of FIG. 10 and the base joint part 963 of FIG. 11 can be settled in the holder joint part 342 of FIG. 4 and the holder joint part 563 of FIG. 6, respectively, by joint means such as a screw. Similarly, the second adhering part 944 of FIG. 10 and the second adhering part 966 of FIG. 11 can be adhered to the first adhering part 344 of FIG. 4 and the first adhering part 566 of FIG. 5, respectively, by an adhering material such as a UV bond.

Referring to FIG. 10 and FIG. 11, the base joint part 942 or 963 and the second adhering part 944 or 966 can be symmetrically arranged in each corner of an edge of the second chamber 910. It is natural that the configuration or number of the base joint part 942 or 963 and the second adhering part 944 or 966 is not limited to the embodiment of FIG. 10 or FIG. 11.

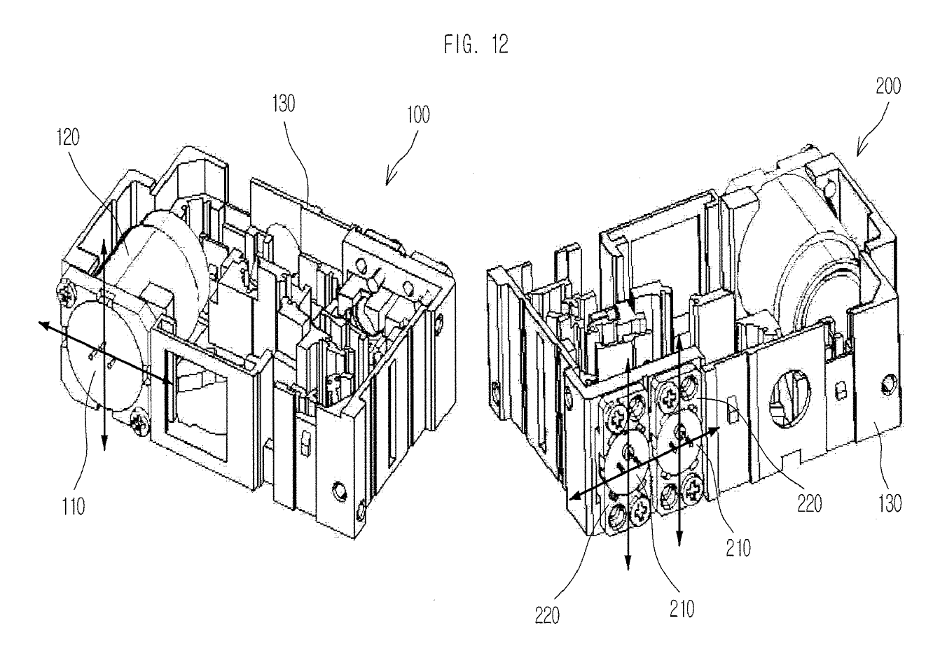

FIG. 12 shows that the position of a light source is adjusted in an embodiment of the present invention. Whether beam of light emitted from the light source 110 or 210 is efficiently used can be determined according to the position of the light source 110 or 210. Accordingly, it is required to adjust the position of the light source 110 or 210 in the optical module 100 or 200. Adjusting the position of the light source 110 or 210 can be performed by changing the position of the light source holder 120 or 220 in the main base 130. At this time, the light source holder 120 or 220 can be settled along with the light source 110 or 210 or can be coupled to the light source 110 or 210.

In accordance with the embodiments of the present invention, the light holder 120 or 220 can have its position changed on a two-dimensional plane in parallel with the second chamber 910. Accordingly, the light source holder 120 or 220 can be more stably settled in the main base 130.

In accordance with the embodiments of the present invention, the position of the light source holder 120 or 220 can be adjusted upper or lower and left or right by two orthogonal axes of the two-dimensional plane. The position adjustment of the two-dimensional plane can have simpler adjustment and shorter adjustment time than that of three-dimensional plane. An error can be also more easily treated and the error generation rate can be lowered in the position adjustment of the two-dimensional plane. In addition, the impact-resisting property of an optical module can be improved because it is possible to stably settle each element.

Hitherto, although some embodiments of the present invention have been shown and described for the above-described objects, it will be appreciated by any person of ordinary skill in the art that a large number of modifications, permutations and additions are possible within the principles and spirit of the invention, the scope of which shall be defined by the appended claims and their equivalents.

What is claimed is:

1. An optical module comprising:
a light source, emitting a predetermined beam of light in the optical module;
a light source holder, including a first chamber accommodating the light source, a first adhering part and a holder joint part being formed in an edge or corner of the first chamber; and
a main base, including a second chamber accommodating the light source holder, a second adhering part that is adhered to the first adhering part and a base joint part that is in contact with the holder joint part being formed in an edge or corner of the second chamber.

2. The optical module of claim 1, wherein the light source has its position changed in a two-dimensional plane in parallel with the second chamber before being settled in the holder.

3. The optical module of claim 2, wherein the light source has its position changed by two orthogonal axes of the two-dimensional plane before being settled in the holder.

4. The optical module of claim 1, wherein the light source emits a laser beam to another element of the optical module through a hole of a bottom surface of the light source holder.

5. The optical module of claim 1, wherein the light source holder accommodates the light source by allowing an inner wall of the first chamber to be in contact with an outer wall of the light source.

6. The optical module of claim 1, wherein the holder joint part is placed at least two of each corner of an upper surface of the light source holder.

7. The optical module of claim 1, wherein the first adhering part is placed at least two of each corner of an upper surface of the light source holder.

8. The optical module of claim 1, wherein the holder joint part is joined to the base joint part by a screw.

9. The optical module of claim 1, wherein the first adhering part is adhered to the second adhering part by applying a UV bond to any one of the first adhering part and the second adhering part.

10. The optical module of claim 1, wherein the light source is a laser diode.

11. The optical module of claim 1, wherein the light source is settled to the light source holder by an adhering material.
